(19) United States
(12) Patent Application Publication
(10) Pub. No.: US 2012/0093619 A1
(43) Pub. Date: Apr. 19, 2012

(54) TAPE CARTRIDGE HANDLER

(75) Inventors: Sheau Yeng Wei, Singapore (SG); Eng Kuan Eikky Lim, Singapore (SG); Chin Tang Tan, Singapore (SG)

(73) Assignee: VENTURE CORPORATION LIMITED, Singapore (SG)

(21) Appl. No.: 13/321,363

(22) PCT Filed: May 19, 2009
(86) PCT No.: PCT/SG2009/000178

§ 371 Date: Nov. 18, 2011

(51) Int. Cl. B65G 1/04

(52) U.S. Cl. 414/267

(57) ABSTRACT

A tape cartridge handler for transmitting a tape cartridge in a tape library. The handler comprises a deck for supporting a tape cartridge thereon; a gripper assembly in translatable engagement with the deck; and at least one arm in rotatable engagement with the gripper assembly, the arm being rotatable about a longitudinal axis of the arm and having a catch for engaging an aperture in a tape cartridge.

### TECHNICAL FIELD

This invention relates generally to a tape cartridge handler, and relates more particularly, though not exclusively, to a handler in a transmission robot for tape cartridge handling in a tape library.

### BACKGROUND

Loading robots are typically used to insert tape cartridges into their respective slots in tape libraries. In order to store as many tape cartridges as possible in a tape library, it is desirable to minimize the space occupied by each slot so as to maximize the number of slots that may be provided in a tape library of a given form factor.

Besides inserting the tape cartridges, the loading robots are also tasked with removing the tape cartridges from their slots. Currently, the robots typically use an arm with a catch at the tip of the arm that hooks into an aperture in the side of the tape cartridge to enable the tape cartridge to be removed from its slot. The arm is typically moved outwardly in an arcuate manner about a first axis by either linkages or a lead screw followed by moving the arm about a second axis in order to engage the catch with the aperture in the tape cartridge.

When space between adjacent stored tapes is reduced or when the slot size is minimized, the clearance between adjacent tape cartridges or the clearance between the tape cartridge and the walls of the slot is correspondingly also reduced. The reduced clearance hinders the currently available arm from executing its sweeping, arcuate movement for engaging the catch with the aperture in the tape cartridge. Using lead screws to drive the arm is also costly to implement.

To increase storage in a tape library by reducing space between adjacent stored tape cartridges or minimizing the tape cartridge slot size, there thus needs to be a loading robot that can cost-effectively remove a tape cartridge from a slot with little clearance between adjacent stored tape cartridges or between the tape cartridge and the walls of the slot.

### SUMMARY

According to a first exemplary aspect there is provided a tape cartridge handler for transmitting a tape cartridge in a tape library. The handler comprises a deck for supporting a tape cartridge thereon; a gripper assembly in translatable engagement with the deck; and at least one arm in rotatable engagement with the gripper assembly, the arm being rotatable about a longitudinal axis of the arm and having a catch for engaging an aperture in a tape cartridge.

Preferably, the arm is rotatable between an engage position and a disengage position; wherein when the arm is in the engage position, the catch can engage the aperture in the tape cartridge; and wherein when the arm is in the disengage position, the arm can translate in a space between two adjacent tape cartridges stored in two corresponding adjacent tape cartridge slots in the tape library. A biasing element is preferably provided for biasing the arm towards the disengage position.

The handler may further comprise a sensor on the gripper assembly for detecting a tape cartridge and triggering rotation of the arm from the disengage position to the engage position. An outwardly extending pivotable flag may be provided on the gripper for triggering the sensor upon contact of the flag with a tape cartridge.

The arm is preferably rotatable via a rack-and-pinion connection with the gripper assembly, the pinion of the rack-and-pinion connection being on the arm such that the longitudinal axis of the arm is co-linear with a rotational axis of the pinion.

The gripper assembly is preferably in translatable engagement with the deck via a rack-and-pinion arrangement, the rack of the rack-and-pinion arrangement being on the deck and the pinion of the rack-and-pinion arrangement being on the gripper assembly. The rack-and-pinion arrangement may comprise two pinions and two racks.

The arm may be retractable with respect to the gripper assembly for loading a tape cartridge from the deck into a tape drive. Preferably, the arm is retractable via a tab-and-stop engagement with the deck, the tab of the tab-and-stop engagement being on the arm and the stop of tab-and-stop engagement being on the deck.

The handler may further comprise a base plate, wherein the deck is in rotatable engagement with the base plate. The deck is preferably in rotatable engagement with the base plate via a sun-and-planet gear arrangement, the planet gear of the sun-and-planet gear arrangement being driveably mounted on the deck and the sun gear of the sun-and-planet gear arrangement being statically provided on the base plate.

A deck sliding surface may be provided on a lower surface of the deck and a corresponding base plate sliding surface may be provided on an upper surface of the base plate such that the deck further slideably engages the base plate during rotational engagement of the deck with the base plate. The deck sliding surface and the base plate sliding surface are preferably highly polished glossy surfaces for smooth sliding engagement of the deck with the base plate.

The handler may further comprise hard stops provided on the deck for engaging end stops provided on the base plate to define relative rotational positions of the deck with respect to the base plate.

The handler may further comprise a flexible printed circuit for providing electrical power from the base plate to the deck.

The handler is preferably configured for use in a tape library that comprises two magazine racks arranged in parallel, each magazine rack comprising a plurality of tape cartridge slots opening into a space between the two magazine racks, and wherein the handler is translatable in the space between the two magazine racks via translation of the base plate, such that appropriate translation of the base plate and appropriate rotation of the deck allows any one of the plurality tape cartridge slots to be accessed by the handler.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings.

In the drawings:

FIG. 1 is a schematic perspective view of an exemplary embodiment of a tape cartridge handler;

FIG. 2 is a schematic perspective view of the tape cartridge handler of FIG. 1 with an arm in a disengage position with respect to a tape cartridge in a tape cartridge slot of a tape library;

FIG. 3 is a schematic perspective view of the tape cartridge handler of FIG. 2 with the arm in an engage position;

FIG. 4 is a close-up view of the arm of FIGS. 1 to 3 in a rack-and-pinion connection with a gripper assembly;

FIG. 5 (a) is a close-up schematic side view of the tape cartridge handler of FIG. 2 with the arm in a disengage position with respect to the tape cartridge;

FIG. 5 (b) is a close-up schematic side view of the tape cartridge handler of FIG. 5 (a) with the arm in an engage position with respect to the tape cartridge;

FIG. 6 is a schematic exploded perspective view of a trigger and sensor on a gripper assembly of the tape cartridge handler of FIG. 1;

FIG. 7 is a close-up schematic perspective view of the trigger and sensor of FIG. 6 with respect to a tape cartridge;

FIG. 8 (a) is a schematic perspective view of the tape cartridge handler of FIG. 1 with a gripper assembly in a retracted position on the deck with respect to a tape cartridge;

FIG. 8 (b) is the tape cartridge handler of FIG. 8 (a) with the gripper assembly in a ready position for the arm to engage the tape cartridge;

FIG. 8 (c) is a close-up schematic perspective view of a rack-and-pinion arrangement for translatable engagement of the gripper assembly with the deck;

FIG. 8 (d) is close-up schematic perspective view of the rack-and-pinion arrangement of FIG. 8 (c) showing a linear guide;

FIG. 9 (a) is a schematic perspective view of the tape cartridge handler of FIG. 1 with the gripper assembly retracted with respect to the deck and a tab on the arm in a turned-down position;

FIG. 9 (b) is the tape cartridge handler of FIG. 9 (a) with the arm in a fully retracted position with respect to the gripper assembly and the gripper assembly in a forward position with respect to the deck;

FIG. 9 (c) is the tape cartridge handler of FIG. 9 (b) in a “parking” position with respect to the deck;

FIG. 10 (a) is a close-up schematic perspective view of the tape cartridge handler of FIG. 1 with the deck in rotatable engagement with a base plate;

FIG. 10 (b) is a close-up schematic perspective view of a static sun gear on the base plate in engagement with a driven planet gear on the deck (hidden);

FIGS. 11 (a) to 11 (c) are schematic plan views of stages of rotation of the deck with respect to the base plate of the tape cartridge handler of FIG. 10 (a);

FIG. 12 is an exploded perspective view of the deck and the base plate of the tape cartridge handler of FIG. 1 showing corresponding sliding surfaces provided on the deck and the base plate and hard stop and end stop locations;

FIG. 13 is a close-up schematic perspective view of the base plate showing hard stop locations for the deck (hidden) at 0 degrees and 180 degrees with respect to corresponding end stops on the base plate;

FIG. 14 is a close-up view of the base plate of FIG. 13 showing a hard stop on the deck (hidden) engaging an end stop on the base plate when the deck is at 0 degrees with respect to the base plate;

FIG. 15 is a schematic plan view of the base plate having a flexible printed circuit;

FIG. 16 (a) is a close up view of the flexible printed circuit of FIG. 15 when the deck is at 0 degrees with respect to the base plate;

FIG. 16 (b) is the flexible printed circuit of FIG. 16 (a) when the deck is at 180 degrees with respect to the base plate; and

FIG. 17 is a schematic of the tape cartridge handler in use with a tape library.

### DETAILED DESCRIPTION OF EXEMPLARY EMBODIMENTS

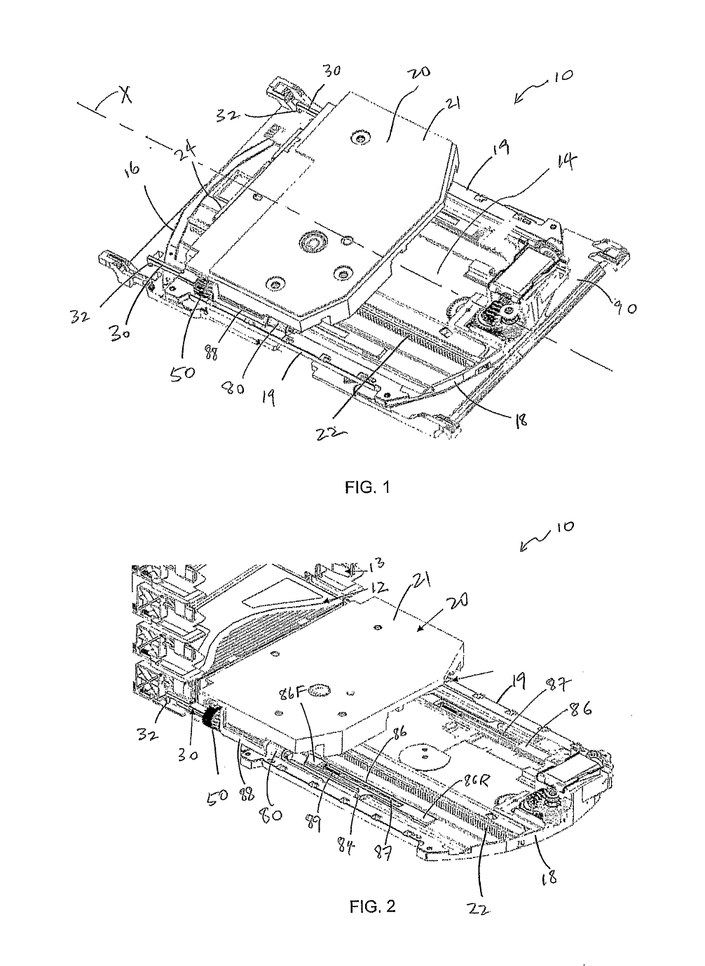

With reference to FIGS. 1 to 3, FIG. 6, FIGS. 8 (a) to 9 (b), a tape cartridge handler 10 is provided for engaging a tape cartridge 12. The handler 10 comprises a deck 14 for supporting the tape cartridge 12 when transporting the tape cartridge 12 from one location to another. The deck 14 has a loading edge 16, a rear edge 18 and two side edges 19. The deck 14 is generally laterally symmetrical about longitudinal axis X.

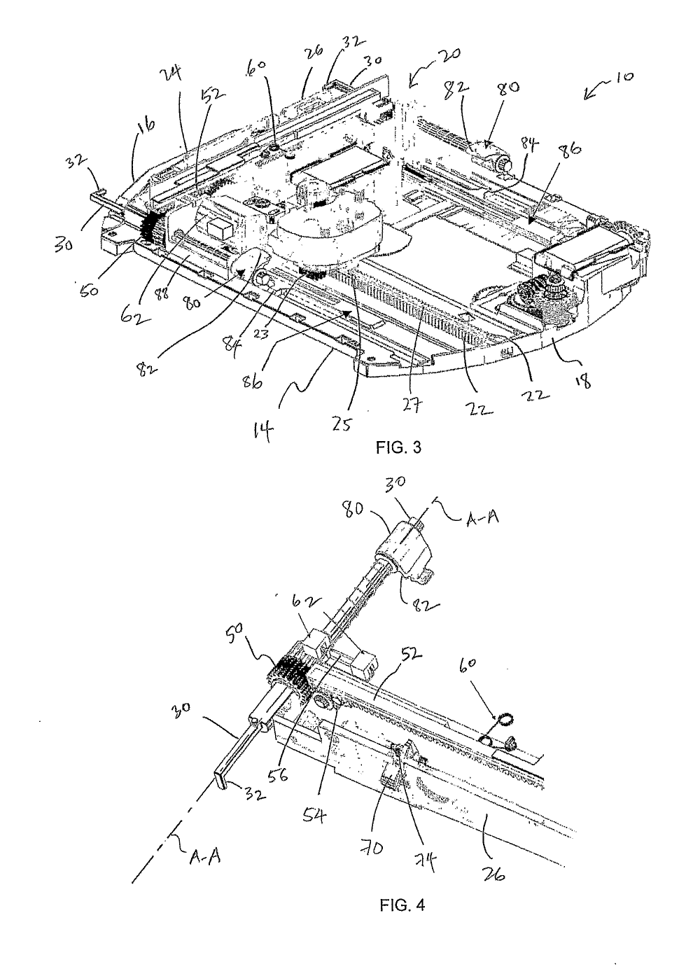

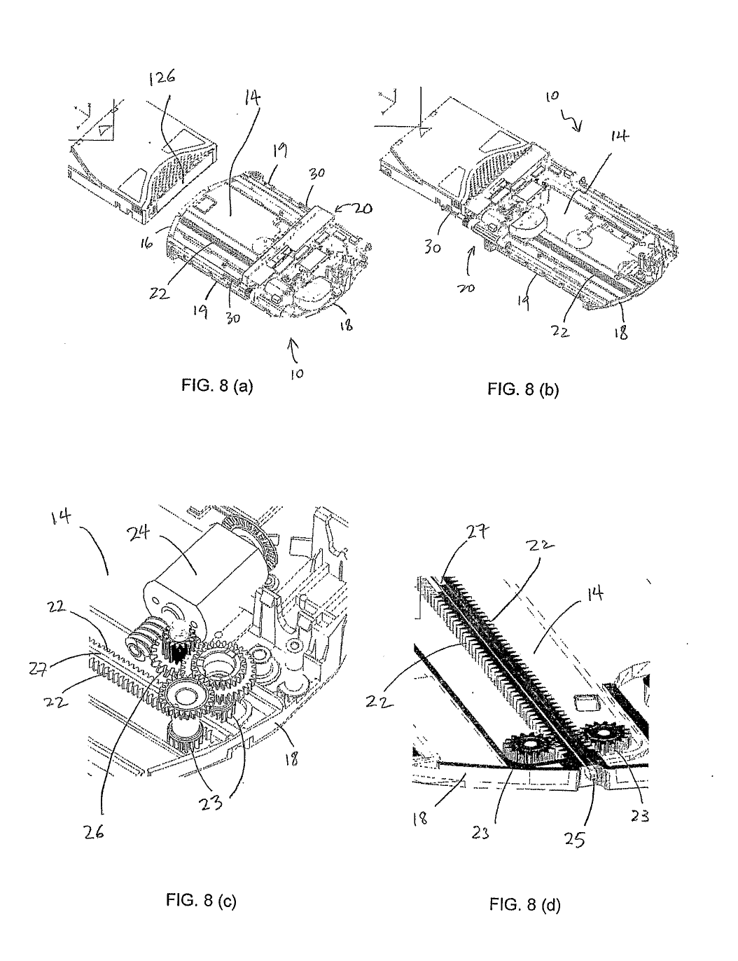

In translatable engagement with the deck 14 is a gripper assembly 20. In FIGS. 3, 6, 8 (a), 8 (b), 9 (a) and 9 (c), a cover 21 of the gripper assembly 20 has been hidden to show the underlying components in the gripper assembly 20. The gripper assembly 20 is preferably in engagement with the deck 14 via a rack-and-pinion system comprising two racks 22 preferably secured to the deck 14 and extending longitudinally relative to the deck 14; and two pinion gears 23 disposed on the gripper assembly 20. The pinion gears 23 are driven by a gripper assembly motor 24 via a gear train 26 on the gripper assembly 20 (hidden in FIG. 8 (c)). The gripper assembly motor 24 is preferably a DC servo motor with an encoder system. Rotation of the pinion gears 23 against the racks 22 moves the gripper assembly along the deck 14 in the direction of the axis X, either towards the loading edge 16 or towards the rear edge 18 of the deck 14.

Preferably, the racks 22 are disposed in parallel on the deck 14 with a linear channel 27 between the two racks 22, while a sheet metal strip 25 as shown in FIG. 3 and FIG. 8 (d) is provided on the gripper assembly 20 (hidden for clarity in FIG. 8 (d)). The sheet metal strip 25 is positioned on the gripper assembly 20 such that the sheet metal strip 25 runs in the channel 17 in sliding engagement with the two racks 22 on the deck 14. The sheet metal strip 25 serves as a linear guide to maintain centre-to-centre distance of the rack-and-pinion system, thereby maintaining linearity of translation of the gripper assembly 20 with respect to the deck 14.

At a front edge 24 of the gripper assembly 20 is a push panel 26 for unloading a tape cartridge 12 from the deck 14, for example, when inserting the tape cartridge 12 into its slot 13 in the tape library. The push panel 26 is operated by advancing the gripper assembly 20 towards the loading edge 16 of the deck 14. As the push panel 26 advances, it contacts a front surface 126 of the tape cartridge 12 resting on the deck 14. Further advancement of the push panel 26 results in the tape cartridge 12 being pushed off the deck 14 and into its slot 13 or into a drive sled.

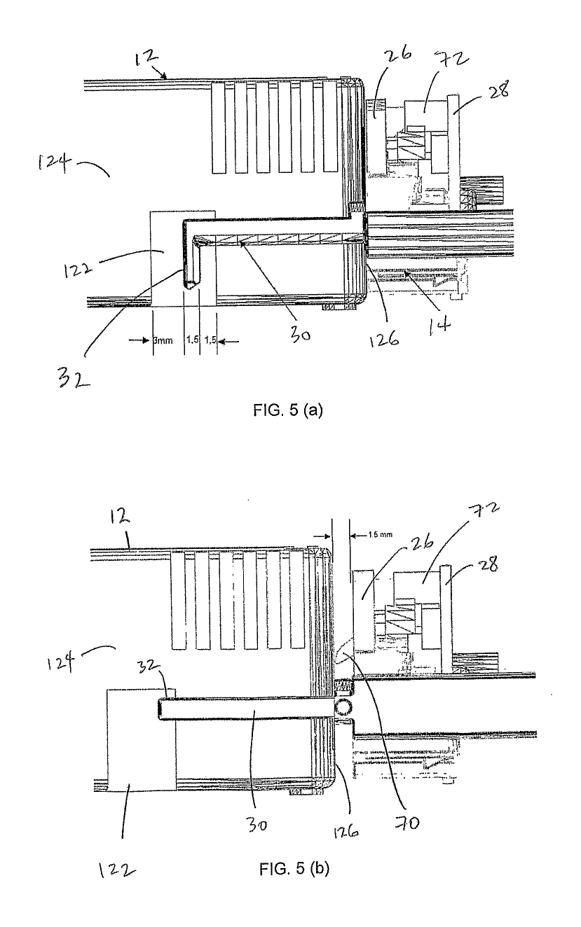

To remove a tape cartridge 12 from a slot 13 of reduced size (not shown), the handler 10 comprises two arms 30 preferably parallel to and symmetrically mounted to the gripper assembly 20. Each arm 30 has a catch 32 at an end away from the gripper assembly 20 adapted for engaging an aperture 122 at a side 124 of the tape cartridge 12 as shown in FIGS. 5 (a) and (b) in order to remove the tape cartridge 12 from its slot (not shown).

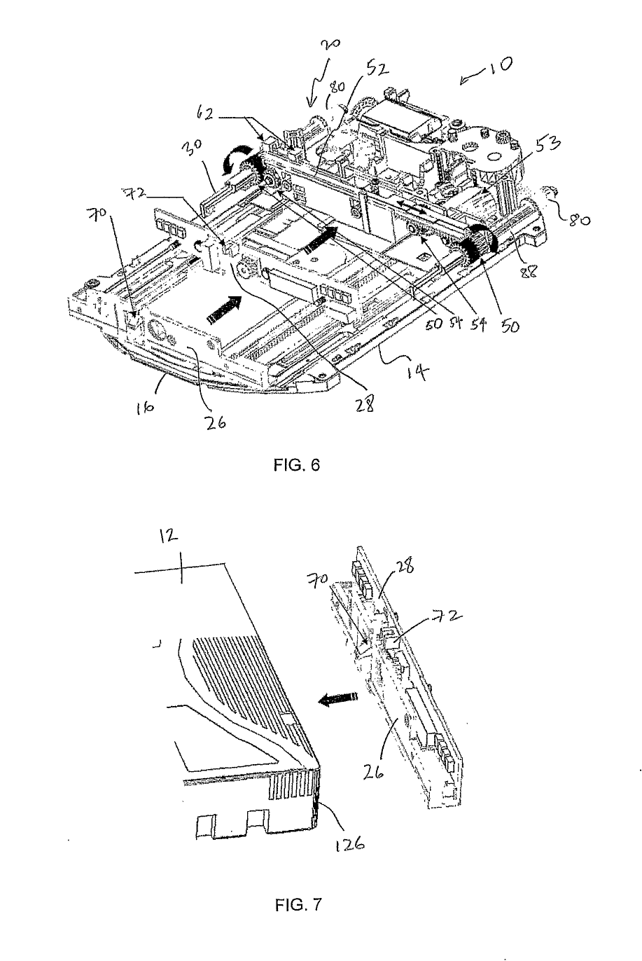

Each arm 30 is in rotatable engagement with the gripper assembly 20 via a rack-and-pinion connection as shown in FIG. 4. Preferably, the pinion 50 of the rack-and-pinion connection is on the arm 30 such that the longitudinal axis A-A of the arm 30 is co-linear with a rotational axis of the pinion 50. The rack 52 of the rack-and-pinion connection is disposed on the gripper assembly 20 and is driven by an arm motor 53 via a gear train 54 on the gripper assembly 20, as shown in FIG. 6. The arm motor 53 is preferably a DC servo motor. The arm 30 is configured to be rotatable about its own longitudinal axis A-A between a disengage position as shown in FIGS. 2 and 5 (a) wherein the catch 32 lies vertically and is pointed downwardly, and an engage position as shown in FIGS. 3 and 5 (b) wherein the catch 32 lies horizontally and is pointed inwardly. In this way, the arm 30 can therefore translate in both directions along the axis X to move in a reduced space between two adjacent tape cartridges 12 stored in two corresponding adjacent tape cartridge slots 13 in the tape library while remaining operable between the disengage and engage positions in the confined space.

As shown in FIG. 4, one end of a toggle spring 60 is attached to the gripper assembly 20 while another end of the toggle spring 60 is attached to the rack 52 of the rack-and-pinion-connection between the arm 30 and the gripper assembly 20. By appropriate attachment of the toggle spring 60, the toggle spring 60 thus acts as a biasing element to bias the arm 30 towards the disengage position.

Sensors 62 are preferably provided to detect the position of a gripper rack flag 56 that is attached to the rack 52, as shown in FIG. 4. The sensors 62 thus provide feedback to the arm motor 53 as to the rotational position of the arm 30 with respect to the gripper assembly 20, i.e., whether the catch 32 of the arm 30 is lying horizontally or vertically downward, or whether the arm 30 is in the engage or disengage position. This also allows the arm motor 53 to compensate for an inherent characteristic of the toggle spring 60 that may allow the catch 32 to remain at 45 degrees downwardly from the horizontal instead of pointing fully vertically downward in the disengage position, such that detection of deviation from the disengage position triggers the arm motor 53 to actively rotate the arm 30 to the disengage position instead of relying solely on the action of the toggle spring 60.

In use, the arm 30 is activated from the disengage to the engage positions by means of a trigger 70 and sensor 72 provided on the gripper assembly 20. The trigger 70 preferably comprises a pivotable tape detection flag 70 mounted on a front face of the push panel 26 as shown in FIGS. 6 and 7. The tape detection flag 70 is pivotable in a plane perpendicular to the plane of the push panel 26 and is preferably connected to the push panel 26 via a torsion spring 74 that biases the tape detection flag 70 in an “Up” position (FIG. 4). The sensor 72 is preferably provided on a secondary panel 28 in the gripper assembly 20, wherein the secondary panel 28 is located behind the push panel 26 with reference to the front edge 16 of the deck 14. The sensor 72 is positioned on the secondary panel 28 such that rotation of the tape detection flag 70 due to depression of the flag 70 upon contact with a tape cartridge 12 causes a rear portion of the tape detection flag 70 to activate the sensor 72. The sensor 72 is thus triggered by the tape detection flag 70 and is connected to the arm motor 53 to correspondingly trigger rotation of the arm 30 from the disengage to the engage position.

Upon pulling out the tape cartridge 12 from its slot 13, as shown in FIG. 5 (b), a gap of 1.5 mm may arise between the push panel 26 and the tape cartridge 12. The tape detection flag 70 and the sensor 72 should thus be appropriately configured to continue to “report” or detect that a tape cartridge 12 is still present in this state, i.e., even when the tape detection flag 70 is not as fully depressed as shown in FIG. 5 (a).

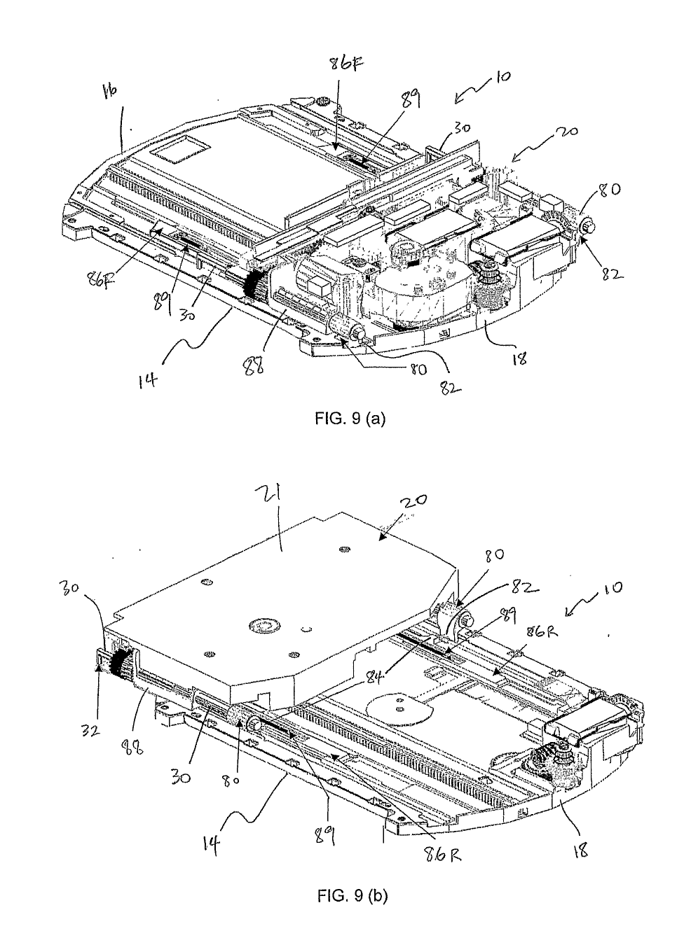

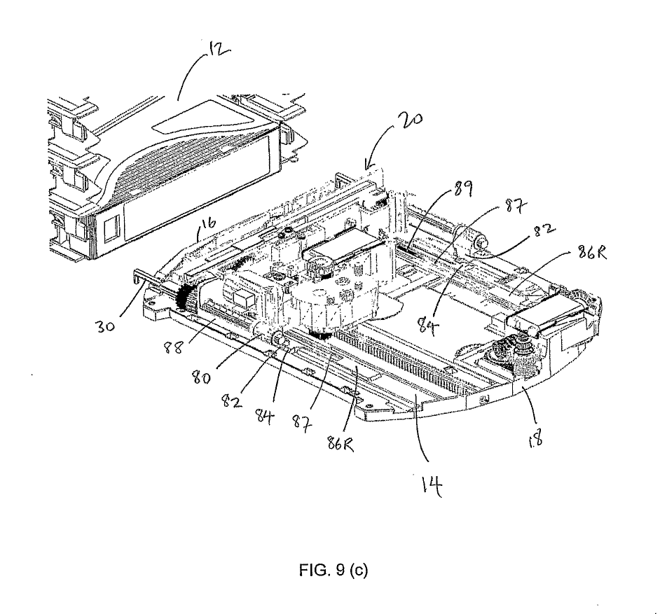

Preferably, the gripper assembly 20 and arm 30 are further configured for the arm 30 to be fully retracted with respect to the gripper assembly 20. The purpose of fully retracting the arm 30 is to ensure that the arm 30 is prevented from inadvertently protruding into a drive sled and getting caught in any features of the drive sled when loading a tape cartridge 12 from the deck 14 into the drive sled. Full retraction of the arm 30 with respect to the gripper assembly 20 is preferably achieved via a sliding engagement of the arm 30 with the gripper assembly 20 together with a tab-and-stop engagement of the arm 30 with the deck 14 as shown in FIGS. 9 (a) and (b).

The sliding engagement of the arm 30 with the gripper assembly 20 is effected by slideably mounting the arm 30 to the gripper assembly 20 via a sliding connector 80. Preferably, the sliding connector 80 is rigidly mounted to the gripper assembly 20 while being slideably mounted to the arm 30 as shown in FIGS. 9 (a) and (b).

The tab-and-stop engagement of the arm 30 with the deck 14 preferably comprises a tabbed sleeve 80 mounted at an opposing end of each arm 30 away from the catch 32, with a corresponding stop 84 mounted on the deck 14 for engaging the tabbed sleeve 80.

Preferably, the tabbed sleeve 80 is co-axial with the longitudinal axis A-A of the arm 30 so that the tabbed sleeve 80 rotates together with the arm 30. Preferably, a tab 82 extends from the sleeve 80 and the sleeve 80 is positioned on the arm such that when the arm 30 is in the engage position as shown in FIG. 3, the extended tab 82 lies substantially horizontally, i.e., parallel to the deck 14; and when the arm 30 is in the disengage position, the tab 82 extends downwardly vertically for engaging the corresponding stop 84 on the deck 14.

The stop 84 on the deck 14 is preferably provided on a slider 86 and extends laterally outwardly from the slider 86 with respect to the deck 14, as shown in FIGS. 2 and 3. In this way, the tab 82 on the arm 30 may engage either a front edge of the stop 84 (nearer the front edge 16 of the deck) or the rear edge of the stop 84 (nearer the rear edge 18 of the deck) as desired, by appropriately rotating the arm 30 such that the tab 82 extends downwardly either in front of the stop 84 or behind the stop 84.

In FIG. 9 (a), the gripper assembly 20 has been translated to its rear-most position with respect to the deck 14. This was achieved by having the arm 30 in the engage position (with the catch 32 lying horizontally) so that the tab 82 was laid horizontally and the gripper assembly 20 could be moved back over the stop 84 without the tab 82 engaging the stop 84. The arm 30 was then rotated to the disengage position as shown in FIG. 9 (a) to turn the tab 82 down in anticipation of fully retracting the arm 30.

From the position in FIG. 9 (a), the gripper assembly 20 was then moved forward with respect to the deck 14 such that the turned down tab 82 engaged the rear edge of the stop 84 as shown in FIG. 9 (b). Further forward movement of the gripper assembly 20 with respect to the deck 14 causes the slider 86 on the deck 14 to be pulled forward with respect to the deck 14.

Preferably, as shown in FIG. 2, the slider 86 comprises a front portion 86F and a rear portion 86R, and further comprises a slider spring 89 disposed in a slot 87 in the slider 86 between the front portion 86F and the rear portion 86R. The slider spring 89 is preferably connected to the front portion 86F at a first end of the spring 89 and connected to the deck 14 at a second end of the spring 89. As the slider 86 is pulled forward by the tab 82 on the arm 30 acting against the stop 84 on the slider, the slider spring 89 is extended, biasing the gripper assembly 20 to return to a “parking” position with respect to the deck 14, as shown in FIG. 9 (c).

When the slider spring 89 has been extended to its limit, the slider 86 can no longer move forward and the arm 30 is likewise prevented from further moving forward by the tab 82 on the arm 30 acting against the stop 84 on the slider 86. In this state, further forward movement by the gripper assembly 20 results in the gripper assembly 20 sliding forward with respect to the stopped arm 30 as a result of the sliding connector 80 sliding forward over the arm 30. In this way, the arm 30 is now fully retracted relative to the gripper assembly 20 as shown in FIG. 9 (b).

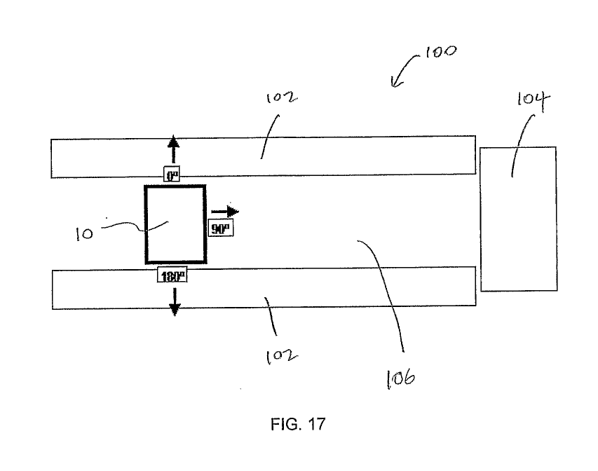

In addition to providing a rotatable arm 30 on a translatable gripper assembly 20, the deck 14 is preferably rotatable with respect to a base plate 90 of the handler 10. This is to allow the tape cartridge handler 10 to be used with a tape library 100 comprising two parallel magazine racks 102 and a drive sled 104 as shown in FIG. 17. Each magazine rack 102 typically comprises a plurality of tape cartridge slots 13 opening into a space 106 between the two magazine racks 102. The handler 10 is configured to be translatable in the space between the two magazine racks via translation of the base plate 90. By allowing configuring the deck 14 to be rotatable with respect to the base plate 90, appropriate translation of the base plate 90 together with appropriate rotation of the deck 14 therefore allows any one of the plurality tape cartridge slots in the magazine racks 102 to be accessed by the handler 102.

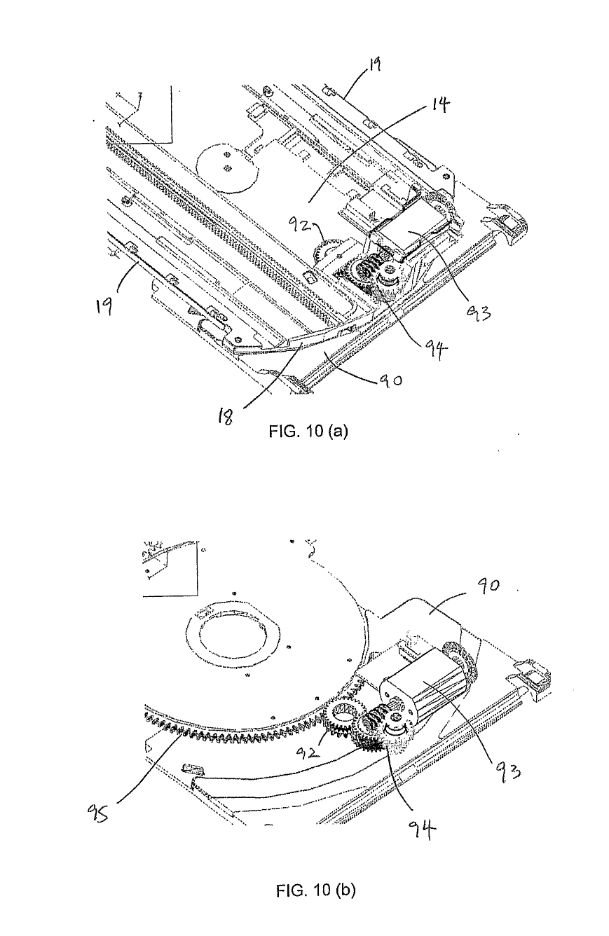

The deck 14 preferably rotatably engages the base plate 90 via a sun-and-planet gear arrangement as shown in FIGS. 10 (a) and (b). Preferably, the planet gear 92 of the sun-and-planet gear arrangement is mounted on the deck 14 and driven by a deck motor 93 via a gear train 94 on the deck 14 as shown in FIG. 10 (a). The deck motor 93 is preferably a DC servo motor with an encoder system.

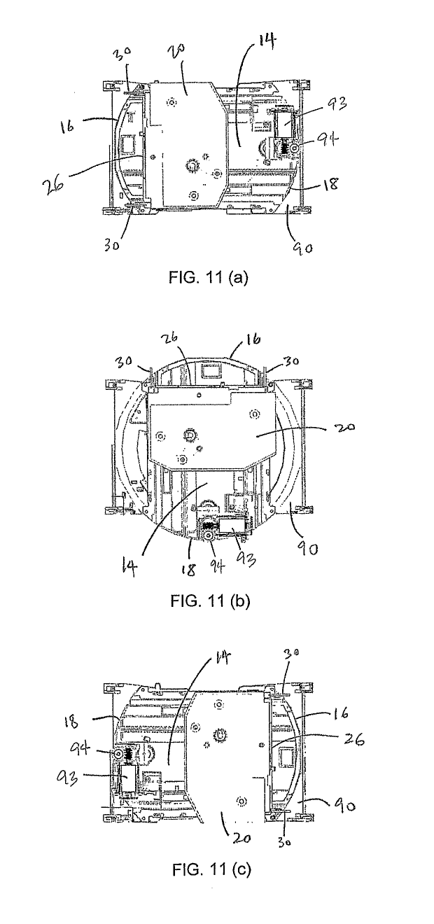

The sun gear 95 of the sun-and-planet gear arrangement is preferably statically provided on the base plate 90 as a raised profile of a spur gear 95 that is preferably integral with the base plate 90. In FIG. 10 (b), the deck 14 has been hidden to show the relative positions of the planet gear 92, deck motor 93 and gear train 94 with respect to the sun gear 95 on the base plate 90. Rotation of the planet gear 92 on the deck 14 while keeping the base plate 10 immobile thus results in rotation of the deck 14 with respect to the base plate 10. As shown in FIGS. 11 (a) to (c), the sun-and-planet gear arrangement is configured to allow rotation of the deck 14 between three distinct stopping positions of the deck 14 with respect to the base plate 90, at Theta=0, 90 and 180 degrees respectively. These stopping positions correspond with the positions of the handler with respect to the tape library 100 shown in FIG. 17.

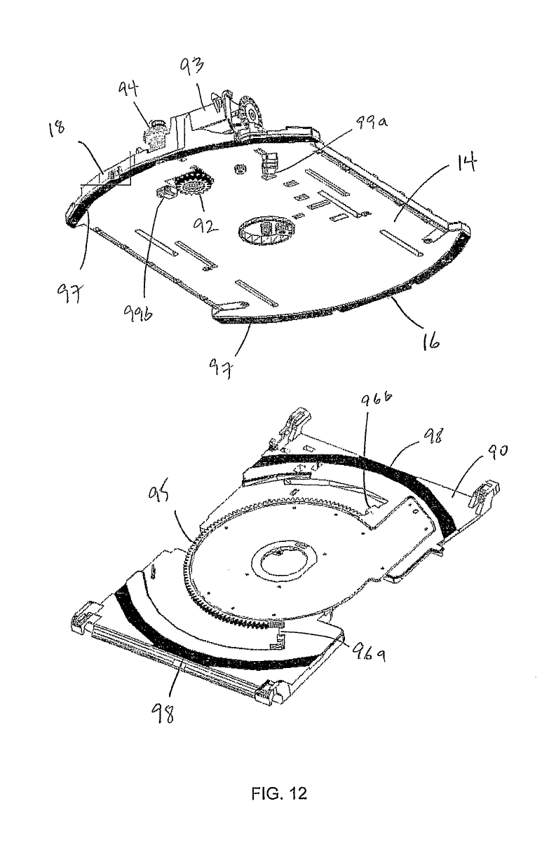

A deck sliding surface 97 is provided on a lower surface of the deck 14 and a corresponding base plate sliding surface 98 is provided on an upper surface of the base plate 90 as shown in FIG. 12, such that the deck 14 further slideably engages the base plate 90 during rotational engagement of the deck 14 with the base plate 90 when the planet gear 92 is activated. The sliding surfaces 97, 98 are preferably highly polished glossy surfaces for smooth sliding engagement of the deck 14 with the base plate 90.

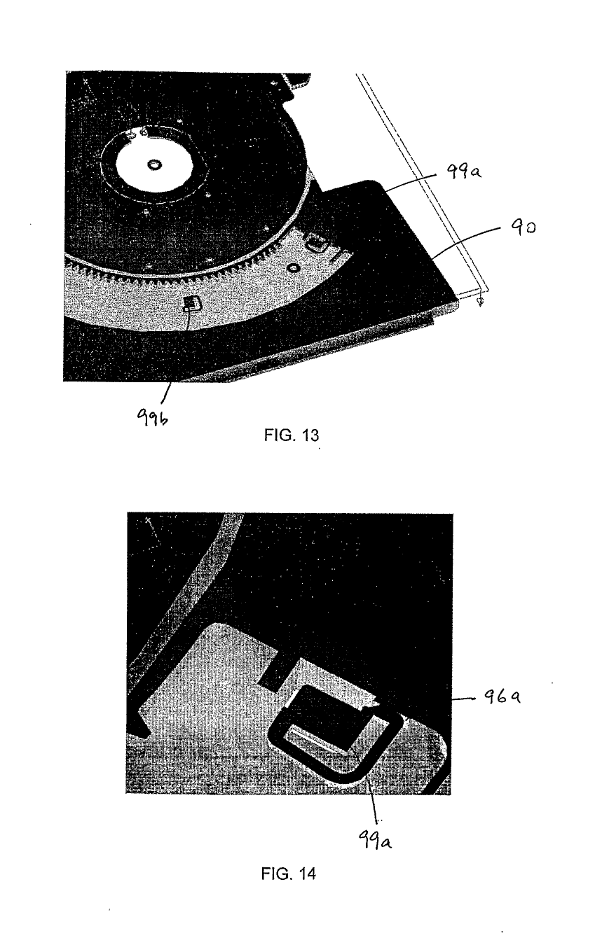

FIGS. 12, 13 and 14 show hard stops 99a and 99b provided on the lower surface of the deck 14 for engaging corresponding end stops 96a and 96b on the base plate 90. The hard stop 99a and end stop 96a serve to define the position of the deck 14 at 0 degrees when engaged with each other, while the hard stop 99b and end stop 96b serve to define the position of the deck 14 at 180 degrees when similarly engaged.

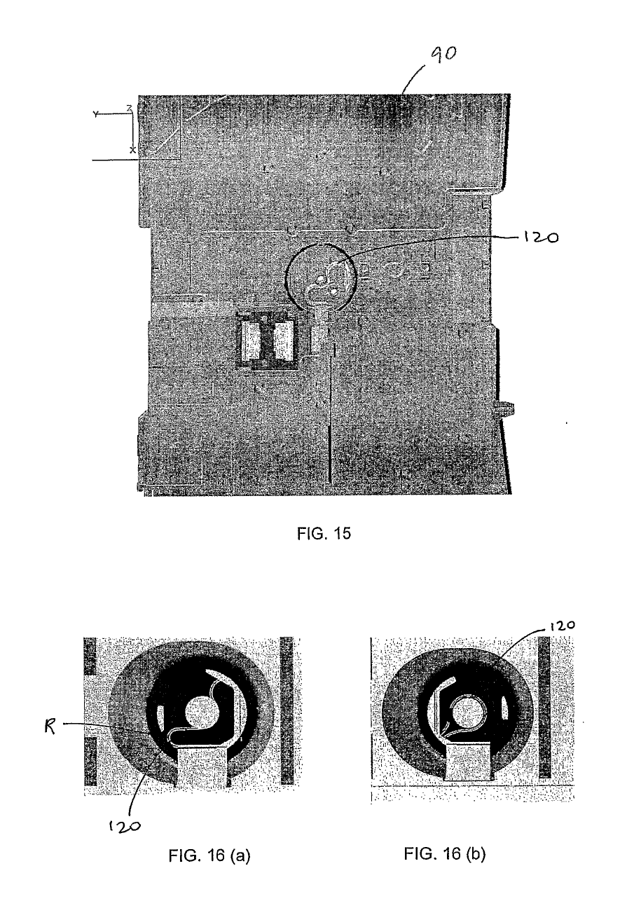

To provide continuous electrical power to the gripper assembly motor 24, arm motor 53 and the deck motor 93 supported on the deck 14, a flexible printed circuit (FPC) 120 is preferably provided on the base plate 90 as shown in FIG. 15 to ensure continue electrical power from the base plate 10 to the deck 14 even when the deck 14 is at different rotational positions with respect to the base plate 10. From an initial heart-shaped arrangement when the deck 14 is at 0 degrees with respect to the base plate 90 as shown in FIG. 16 (a), the FPC 120 changes shape to that shown in FIG. 16 (b) when the deck is rotated to 180 degrees with respect to the base plate 90. It has been found that bending radius R of the FPC 120 dictates its life expectancy and the FPC 120 should be configured to withstand more than two hundred thousand cycles of folding and unfolding when the deck 14 rotates.

By having rotatable arms 30 as described above for extracting a tape cartridge 12 from a slot 13 in the tape library 100, the handler 10 is therefore able to operate in a tape library 100 having reduced clearance between adjacent stored tape cartridges or reduced clearance between a tape cartridge 12 and the walls of the slot 13. By having a deck 14 rotatably engaging a translatable base plate 90, the handler 10 is further able to operate in a tape library 100 that comprises more than one magazine rack 102. The handler 10 as described above therefore allows storage capacity of the tape library 100 in which it is used to be maximized for a given footprint and form factor of the tape library 100.

Whilst there has been described in the foregoing description exemplary embodiments of the present invention, it will be understood by those skilled in the technology concerned that many variations in details of design, construction and/or operation may be made without departing from the present invention.

1. A tape cartridge handler for transmitting a tape cartridge in a tape library, the handler comprising:
a deck for supporting a tape cartridge thereon;
a gripper assembly in translatable engagement with the deck; and
at least one arm in rotatable engagement with the gripper assembly, the arm being rotatable about a longitudinal axis of the arm and having a catch for engaging an aperture in a tape cartridge.

2. The handler of claim 1, wherein the arm is rotatable between an engage position and a disengage position; wherein when the arm is in the engage position, the catch can engage the aperture in the tape cartridge; and wherein when the arm is in the disengage position, the arm can translate in a space between two adjacent tape cartridges stored in two corresponding adjacent tape cartridge slots in the tape library.

3. The handler of claim 2, further comprising a biasing element for biasing the arm toward the disengage position.

4. The handler of claim 2, further comprising a sensor on the gripper assembly for detecting a tape cartridge and triggering rotation of the arm from the disengage position.

5. The handler of claim 4, further comprising an outwardly extending pivotable flag on the gripper for triggering the sensor upon contact of the flag with a tape cartridge.

6. The handler of claim 1, wherein the arm is rotatable via a rack-and-pinion connection with the gripper assembly, the pinion of the rack-and-pinion connection being on the arm such that the longitudinal axis of the arm is co-linear with a rotational axis of pinion.

7. The handler of claim 1, wherein the gripper assembly is in translatable engagement with the deck via a rack-and-pinion arrangement, the rack of the rack-and-pinion arrangement being on the deck and the pinion of the rack-and-pinion arrangement being on the gripper assembly.

8. The handler of claim 7, wherein the rack-and-pinion arrangement comprises two pinions and two racks.

9. The handler of claim 1, wherein the arm is retractable with respect to the gripper assembly for loading a tape cartridge from the deck into a tape drive.

10. The handler of claim 9, wherein the arm is retractable via a tab-and-stop engagement with the deck, the tab of the tab-and-stop engagement being on the arm and the stop of tab-and-stop engagement being on the arm and the stop of tab-and-stop engagement being on the deck.

11. The handler of claim 1, further comprising a base plate, wherein the deck is in rotatable engagement with the base plate.

12. The handler of claim 11, wherein the deck is in rotatable engagement with the base plate via a sun-and-planet gear arrangement, the planet gear of the sun-and-planet gear arrangement being driveably mounted on the deck and the sun gear of the sun-and-planet gear arrangement being statically provided on the base plate.

13. The handler of claim 11, wherein a deck sliding surface is provided on a lower surface of the deck and a corresponding base plate sliding surface is provided on an upper surface of the base plate such that the deck further slideably engages the base plate during rotational engagement of the deck with the base plate.

14. The handler of claim 13, wherein the deck sliding surface and the base plate sliding surface are highly polished glossy surfaces for sooth sliding engagement of the deck with the base plate.

15. The handler of claim 11, further comprising hard stops provided on the deck for engaging end stops provided on the base plate to define relative rotational positions of the deck with respect to the base plate.

16. The handler of claim 11, further comprising a flexible printed circuit for providing electrical power from the base plate to the deck.

17. The handler of claim 11, wherein the tape library comprises two magazine racks arranged in parallel, each magazine rack comprising a plurality of tape cartridge slots opening into a space between the two magazine racks, and wherein the handler is translatable in the space between the two magazine racks via translation of the base plate, such that appropriate translation of the base plate and appropriate rotation of the deck allows any one of the plurality tape cartridge slots to be accessed by the handler.
